(19) United States
(12) Patent Application Publication
(10) Pub. No.: US 2012/0241534 A1
(43) Pub. Date: Sep. 27, 2012

(54) IRRIGATION LINE GUIDE AND METHOD OF IRRIGATING

(76) Inventors: Chris Clay, Allenton (NZ); Jonathan Gray, Ashburton (NZ); Anthony Atwool, Timaru (NZ)

(21) Appl. No.: 13/172,008

(22) Filed: Jun. 29, 2011

(30) Foreign Application Priority Data
Mar. 23, 2011 (NZ) 591881

(51) Int. Cl. B05B 15/00; B65H 75/38

(52) U.S. Cl. 239/1; 239/743; 242/397.5

(57) ABSTRACT

An irrigation hose guide is provided, including a ground engaging portion; and a revolvable device rotatably mounted on the ground engaging portion about a vertical rotation axis, wherein the revolvable device is configured to accommodate irrigation nodes on an irrigation hose line.

### FIELD OF INVENTION

The invention relates to irrigation systems and methods. More particularly, the invention relates to a guide for an irrigation line and a method of irrigating therewith.

### BACKGROUND

There are many kinds of irrigation systems used in agriculture. These range from irrigation systems for large commercial farming estates to systems suitable for smaller commercial holdings.

One type of system often used on smaller farms is a low-volume low-pressure sprinkler system. Such a system typically comprises a flexible hose line with sprinkler heads placed at desired positions along the line to irrigate a field or paddock. These systems are relatively cheap to operate and can be easily moved around by a farmer using a small vehicle such as a quad bike.

The RX Plastics K-Line® irrigation system is one example of such an irrigation system. A series of small, tough plastic pods protect small sprinklers attached to a low density hose line. Aspects of this system are described in NZ 331985. The system is easy to install and can be used on any type of terrain because of the flexible hose line. The line can easily be moved from one position to another using any small farm vehicle.

Although a flexible hose line can be easy to move from one position to another, it can be difficult, or at least time consuming, to arrange in the required configuration for irrigating. When a flexible hose line is towed it tends to be pulled into a straight line behind the towing vehicle. This may not be the required arrangement of the line and therefore the line may need re-arranging.

In some situations, flexible hose line systems which can be easily moved can cause problems. For example, where the irrigation system is used in an orchard or field with a large crop, moving the hose line around the trees or crops can be difficult. The line or sprinkler heads on the line may become snagged against a crop or tangled. A similar difficulty can arise when trying to move hoses through gates from one paddock to the next. These kinds of problems mean the farmer must dismount their vehicle and unsnag or untangle the line before being able continue, wasting the farmer's valuable time.

In fields with some other types of crop, moving the hose line sideways may cause undesirable damage to the crop. For example, the sprinkler heads, sprinkler pods or the line itself may collide with the crop, causing it to be flattened or broken.

### SUMMARY

In general non-limiting terms, the invention relates to a device for guiding an irrigation hose such that the hose can be laid out with bends in it around crops and the like. The hose guide has a rotatable reel which rotates as the hose is pulled around it and allows irrigation nodes positioned on the hose to pass around it. The invention also relates to methods for using the hose guide in irrigation.

According to a first aspect of the invention, there is provided an irrigation hose guide comprising:
a ground engaging portion; and
a revolvable device rotatably mounted on the ground engaging portion about a vertical rotation axis,
wherein the revolvable device is configured to accommodate irrigation nodes on an irrigation hose line.

The revolvable device may comprise a plurality of spaced apart vertically aligned outer surface portions. Ideally, the outer surface portions are spaced to accommodate the irrigation nodes therebetween.

The outer surface portions may be separated by a plurality of recesses adapted to accommodate the irrigation nodes.

The outer surface portions may be adapted to frictionally engage the irrigation hose/nodes such that movement of the irrigation hose/nodes relative to the irrigation hose guide can cause the revolvable device to rotate.

The revolvable device may be in the form of a reel.

Preferably, the reel comprises at least one hub and a frame connected thereto.

Ideally, the reel may comprise upper and lower reel portions separated by the plurality of outer surface portions.

Preferably, each outer surface portion comprises a flexible strap connected between the upper and lower reel portions.

Preferably, the upper and lower reel portions each comprise a rim and a plurality of spokes connecting the rim to the hub.

Preferably, the reel comprises a plurality of support struts that may connect the upper and lower reel portions.

Preferably, the outer surface portions are aligned with the spokes.

The base may be freestanding. Preferably, the base may be transportable.

According to a second aspect of the invention, there is provided an irrigation hose guide comprising:
a ground engaging portion; and
a revolvable device rotatably mounted on the ground engaging portion about a vertical rotation axis,
wherein the revolvable device is configured to rotate as a result of the relative movement of an irrigation hose line in contact with the revolvable device.

The revolvable device may comprise irrigation hose contact portions. In some further aspects the revolvable device may comprise irrigation node receiving portions.

Preferably, the revolvable device comprises a plurality of spaced apart vertically aligned outer surface portions. More preferably, the outer surface portions are spaced to accommodate the irrigation nodes therebetween.

According to a third aspect of the invention, there is provided an irrigation hose guide comprising:
a ground engaging portion; and
a revolvable device rotatably mounted on the ground engaging portion about a vertical rotation axis,
wherein the ground engaging portion is freestanding and transportable.

The ground engaging portion may be a freestanding base.

According to a fourth aspect of the invention, there is provided an irrigation system comprising:
a hose adapted to be connected at one end to a water source;
a plurality of irrigation nodes along the hose; and
one or more irrigation hose guides according to the first, second or third aspects of the invention,
wherein the hose is adapted to be towed by a vehicle to position the hose for irrigation, and the irrigation hose guides are positioned at one or more points at which the towed hose needs to be re-directed.

Preferably, each irrigation node comprises a sprinkler head and protective pod.

According to a fifth aspect of the invention, there is provided a method of setting up an irrigation system comprising the step of:
positioning one or more irrigation hose guides according to the first, second or third aspects of the invention at one or more points at which the irrigation hose is required to change direction.

Preferably, the method further comprises towing an irrigation hose having a plurality of irrigation nodes along its length to an irrigation position such that the irrigation hose may be towed around the irrigation hose guides and changes direction around the irrigation hose guides.

Preferably, each irrigation node comprises a sprinkler head and protective pod.

Preferably, the method comprises towing the irrigation hose such that the hose contacts the irrigation hose guides and slides in relation thereto, causing the irrigation hose guides to rotate.

Preferably, the irrigation hose is towed using a vehicle. The vehicle may include any means appropriate for towing an irrigation hose but in preferred embodiments may be a quad bike, motorcycle, tractor or automobile.

Preferably, the method comprises hitching the irrigation hose to the vehicle for towing.

According to a sixth aspect of the invention, there is provided a method of irrigating comprising the steps of:
positioning one or more irrigation hose guides according to the first, second or third aspects of the invention at one or more points at which an irrigation hose is required to change direction;
towing an irrigation hose having a plurality of irrigation nodes along its length to an irrigation position such that the irrigation hose is towed around the irrigation hose guides and changes direction around the irrigation hose guides; and
connecting a water supply to the irrigation hose.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

One or more embodiments of the invention will be described below by way of example only, and without intending to be limiting, with reference to the following drawings, in which:

FIG. 1 is a perspective view illustration of an irrigation hose guide according to an embodiment of the invention;

FIG. 2 is a schematic illustration of an area to be irrigated before moving an irrigation line according to an embodiment of the invention; and

FIG. 3 is a schematic illustration of an area to be irrigated after moving an irrigation line according to an embodiment of the invention.

### DETAILED DESCRIPTION

### Irrigation Hose Guide

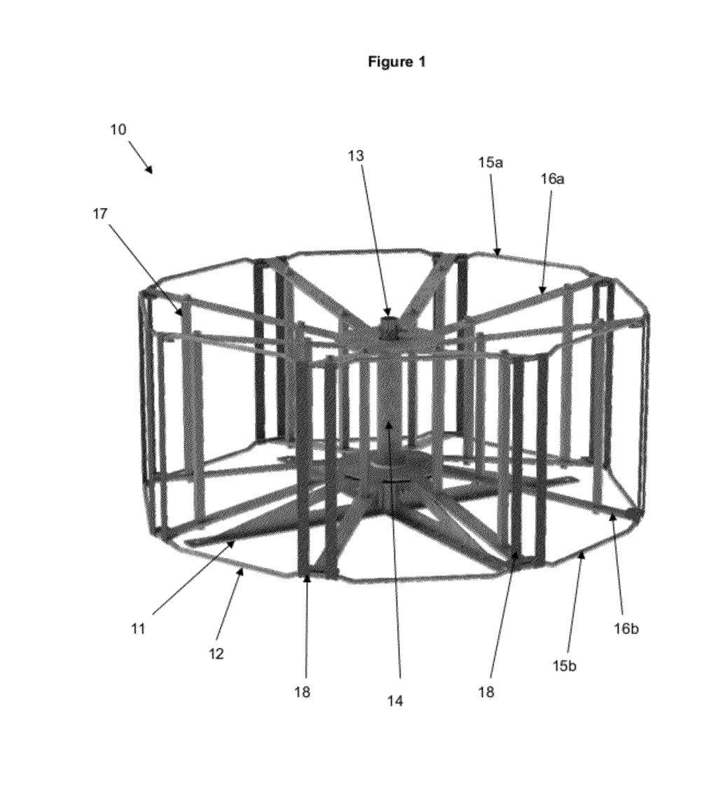

FIG. 1 is a perspective view illustration of an irrigation hose guide 10 according to an embodiment of the invention.

Irrigation hose guide 10 comprises a ground engaging portion in the form of 11 and a revolvable device in the form of reel 12 rotatably mounted on base 11 around a substantially vertical rotation axis. Reel 12 may be rotatably mounted on base 11 by any known means, but in the embodiment shown in FIG. 1, base 11 comprises an upwardly extending axle 13 which passes through a hub portion 14 of reel 12. Base 11 is a stand having four perpendicularly oriented legs to provide a solid base for irrigation hose guide 10.

In the embodiment shown, reel 12 comprises a frame connected to hub portion 14. The frame comprises upper and lower reel portions, each of which comprise a rim 15a, 15b and a plurality of spokes 16a, 16b connecting the rims to hub portion 14. This construction of the reel is advantageous because it is light and strong. A plurality of struts 17 are preferably used to connect the upper and lower reel portions to provide additional strength to the frame structure.

Base 11 and the frame of reel 12 are preferably constructed from a strong, weather-proof material such as stainless or galvanised steel. Other materials may be used in alternative embodiments of the invention.

Reel 12 is configured to accommodate irrigation nodes on an irrigation hose line. For example, reel 12 may comprise a plurality of outer surface portions 18. Outer surface portions 18 are substantially vertically aligned between the upper and lower reel portions and are generally equally spaced around the perimeter of the reel. The spacing of the outer surface portions 18, and the width of the recesses between them, are dimensioned to accommodate other elements of the irrigation system with which irrigation line guide 10 is intended to be used, as will be described in further detail below.

In the embodiment shown in FIG. 1, outer surface portions 18 comprise straps connected between the upper and lower reel portions. The straps are preferably aligned with spokes 16 since the spokes mark the strongest points around the perimeter of the reel and the straps are subject to force when hose guide 10 is used with an irrigation hose.

The straps may be connected between upper and lower reel portions under tension or with a degree of slack. When an irrigation hose is run around the hose guide, the straps preferably bend under the strain of the hose such that the hose is tended to be held around reel 12 between the upper and lower reel portions, which has been found to limit kinking of the hose.

Outer surface portions 18 preferably have a surface that is able to engage in frictional contact with an irrigation hose such that movement of the irrigation hose around reel 12 when there is contact between the hose and reel causes the reel to rotate. For example, the outer surface portions may comprise a material that promotes frictional contact with a hose. Alternatively, the surface of the outer surface portions may comprise grooves or the like to promote frictional contact.

The ground engaging portion of irrigation hose guide 10 is freestanding in that it is not irreversibly fixed to the ground. This provides the advantage that it can be quickly and easily moved around from one position to another for the purposes of setting up an irrigation system, as will be described below. The entire hose guide is easily transportable and can be moved around by hand or by using standard farm transport means.

### Use of the Irrigation Hose Guide in Irrigation

There will now be described use of an irrigation hose guide according to the invention for irrigation. For the purposes of the following description, the invention will be discussed with reference to its use with the RX Plastics K-Line® irrigation system. However, it will be understood that reference to this irrigation system is merely set out by way of example. Irrigation hose guides according to the invention may be used with a number of irrigation systems, as will be appreciated by those of skill in the art.

An irrigation system according to embodiments of the invention comprises a hose that is adapted to be connected at one end to a water source and a number of irrigation nodes positioned along the length of the hose. An irrigation node is a structure at which water is released from the hose for irrigation. In one embodiment of the invention, the irrigation nodes along the hose each comprise a sprinkler head and protective pod, for example as described in NZ 331985, the contents of which are incorporated herein by reference. In other embodiments, the irrigation nodes may take other forms, for example they may comprise only sprinkler heads or alternative protective casings.

The irrigation hose is adapted to be towed by a vehicle. Typically, it is envisaged that a farm vehicle such as a quad bike, motorcycle, tractor or automobile would be used for towing the irrigation hose since these vehicles are particularly suited for driving around fields, paddocks and farm terrain. However, the invention is not limited to any particularly type of vehicle and any suitable means may be used to tow the irrigation hose. In some embodiments, animals such as horses may be used as vehicles to tow the irrigation hose.

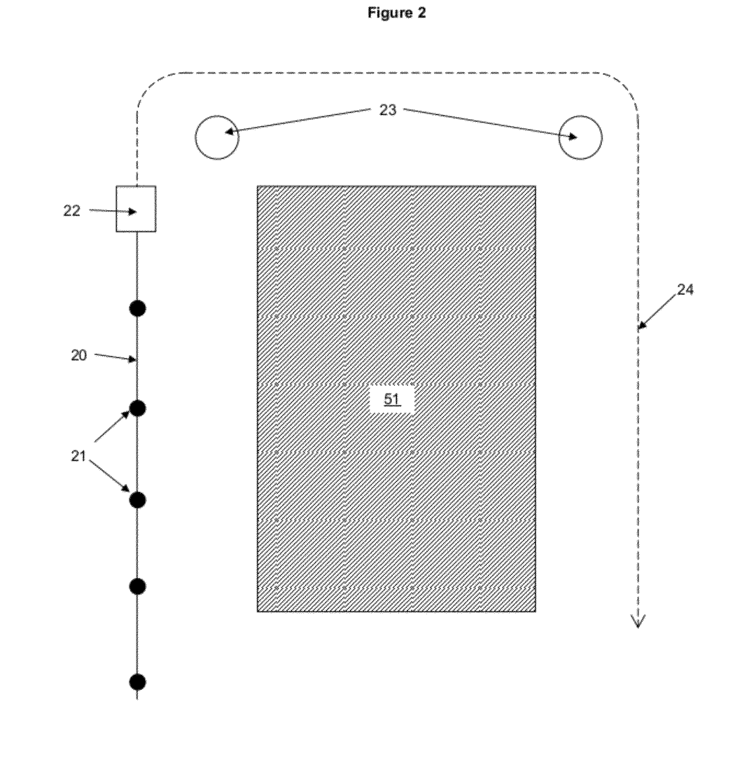

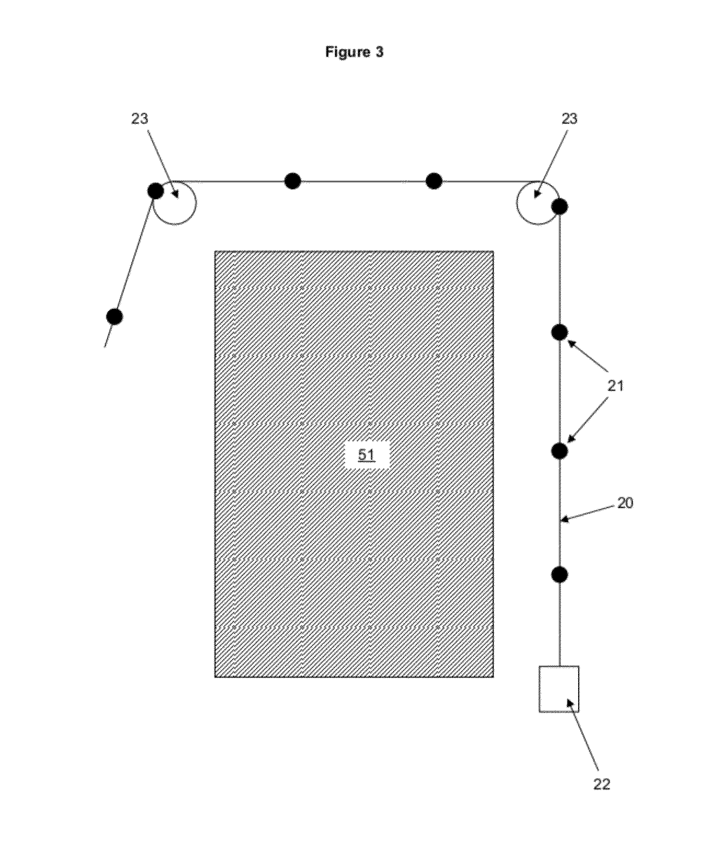

There will now be discussed use of an irrigation system as described above to position an irrigation hose and therefore to irrigate with reference to FIGS. 2 and 3, which are schematic illustrations of an area to be irrigated.

An irrigation hose 20 is located in a first position on the left hand side of FIG. 2. Hose 20 comprises a plurality of irrigation nodes 21 spaced along its length. In the embodiment shown in FIG. 2, irrigation nodes 21 comprise a sprinkler head and a protective pod.

Hose 20 may have been stored in the first position or been in this position for an earlier spell of irrigation. It is desired to move hose 20 to a second position on the right hand side of FIG. 2 in such a way that hose 20 does not pass over area 51. It may be desirable to avoid the hose passing over area 51 for a number of reasons. For example, area 51 may represent the area occupied by a crop that is vulnerable to damage if hose 20 and/or irrigation nodes 21 pass over the crop. Alternatively, area 51 may represent an orchard in which hose 20 may be likely to be tangled or an area of land that generally may be likely to cause problems if the hose slides over it, for example a steep valley, river, rocky outcrop, etc.

In order to move hose 20, it is connected to vehicle 22. For example, the end of hose 20 distant from the end of the hose connected to a water source is hitched to a fixing on vehicle 22.

Prior to moving hose 20, irrigation hose guides are positioned to ensure hose 20 does not move across area 51. In the example of FIG. 20, hose guides 23 are positioned adjacent to the corners of area 51 at points at which it is desired to change the direction of hose 20 as it is being towed.

Appropriate positioning of hose guides 23 can be determined by considering the proposed path 24 along which vehicle 22 will travel to move hose 20 from its position on the left side of area 51 to a position on the right side of area 51. While vehicle 22 moves in a straight line, hose 20 will follow substantially the same path. However, when vehicle 22 moves around a corner, hose 20 will tend to follow the shortest available path and at least partially cut the corner as it is being dragged, thus potentially encroaching on area 51. Hose guides 23 are therefore positioned at one or more points at which the towed hose needs to be re-directed, or change direction from its previously towed path. Through appropriate positioning of hose guides 23, a hose can be placed accurately, for example alongside a row of crops, and can reach the desired placement by being towed along a desired path.

Once hose guides 23 are appropriately positioned, vehicle 22 moves along path 24, towing hose 20 along behind it.

FIG. 3 illustrates the irrigation area of FIG. 2 as vehicle 22 tows hose 20 towards its desired position on the right hand side of area 51. When vehicle 22 moves around a corner, hose 20 will tend to cut the corner until it comes into contact with hose guide 23. Hose guide 23 prevents the hose cutting any more of the corner and encroaching on area 51.

As hose 20 is continued to be pulled it slides relative to the outer surface portions of hose guide 23 and the frictional contact between the hose and hose guide causes the reel of the hose guide to rotate about its vertical axis.

As hose 20 is pulled further forwards, one or more of the irrigation nodes 21 will come into contact with the hose guide. Movement of the irrigation nodes around the hose guide is assisted by the rotation of the hose guide reel around its vertical axis and the spacings between the vertically aligned outer surface portions of the reel. More particularly, an irrigation node is likely to snag or be difficult to pull around the hose guide, but rotation of the reel leads to the irrigation node being accommodated in one of the spacings or recesses between the reel's spaced apart outer surface portions by sinking in to the reel such that the node is held between vertically aligned outer surface portions. As the reel continues to rotate, the irrigation node is pushed around the hose guide until the towed hose pulls away from the hose guide.

In the case of an irrigation node consisting of a protective pod, the spacings between outer surface portions on the hose guide are adapted to accommodate a protective pod such that a pod can be received in the spacing in order to be pushed around the outside of the hose guide as it rotates. It will be appreciated by those of skill in the art how spacings between outer surface portions may be adapted to receive irrigation nodes having different forms.

As shown in FIGS. 2 and 3, more than one hose guide may be used to re-direct the irrigation hose. In FIG. 3, irrigation hose 20 is in contact with two hose guides 23 simultaneously to change the direction of the hose around two corners as it is towed. Those of skill in the art will appreciate that any number of hose guides may be used to divert the path of the hose according to requirements. The more hose guides that are used, the more friction will be imparted on the hose by the guides and therefore the more energy is required to tow the hose. If only a limited number of hose guides are available, it may be necessary to tow the hose part of the way to the final destination using the hose guides, before moving the hose guides to the appropriate positions for moving the hose the rest of the way to the final destination.

Once the irrigation hose is in the desired position, the hose is preferably decoupled from the towing vehicle before water is supplied to the irrigation hose. To further move the irrigation hose, the water supply is typically disconnected before towing the hose to the next desired position, although the hose can, in some embodiments, be towed with the water supply turned on.

Hose guides according to the invention permit more accurate placement of a hose and irrigation nodes in any field, for example according to a desired layout. Furthermore, hose guides can be used when moving a hose from one paddock to another to ensure the hose passes through a gate without becoming snagged, for example.

### ALTERNATIVE EMBODIMENTS OF THE INVENTION

In the embodiment discussed above, the irrigation hose guide is freestanding. However, in some embodiments the ground engaging portion comprises a ground anchor to assist in maintaining the hose guide in the desired location during use, despite the sideways forces that may be exerted on it by towing the hose around it. For example, the ground engaging portion may comprise one or more stakes or spikes that is/are adapted to be inserted into the ground.

In one embodiment, the ground engaging portion comprises a plurality of spiral-shaped ground anchors connected to the legs of the ground engaging base of the hose guide.

In alternative embodiments, the ground engaging portion of the hose guide is adapted to be inserted into a shallow hole dug into the ground such that the base is held in place but the reel is able to rotate without being impinged by the ground.

In alternative embodiments of the invention, the irrigation hose guide revolvable device may take different forms. For example, in one embodiment, the revolvable device comprises an enclosed, hollow body having a central hole for receiving the vertical axis, protuberances on its outer surface comprising the outer surface portions and depressions between said protuberances for receiving the irrigation nodes of the hose.

The outer surface protuberances may also comprise small grooves for receiving the hose and tending to maintain the hose within the grooves during use. In this embodiment, the reel body may be made from a plastics material.

In some embodiments, recesses in the revolvable device may comprise gaps or depressions in the surface for accommodating irrigation nodes therein.

In one embodiment, the revolvable device may have a flexible surface adapted to receive irrigation nodes. For example, a rubber surface may flex more when an irrigation node contacts it, thus providing a recess that can aid in pushing the irrigation node around the hose guide.

In one embodiment, the revolvable device comprises a rotation axis which extends into a hub portion of the base. More generally, any means for allowing rotation between the ground engaging means and revolvable device is incorporated within the scope of the invention.

The revolvable device has been discussed with reference to the example of a reel. In other embodiments, other forms of revolvable device may be used, including any means configured to accommodate irrigation nodes or an irrigation line. For example, non-substantially cylindrical revolvable devices are included within the scope of the invention. In one embodiment, the revolvable device receives an irrigation line/irrigation nodes on an upper surface thereof, for example in appropriately sized and shaped depressions or gaps.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. An irrigation hose guide comprising:
a ground engaging portion; and
a revolvable device rotatably mounted on the ground engaging portion about a vertical rotation axis,
wherein the revolvable device is configured to accommodate irrigation nodes on an irrigation hose line.

2. An irrigation hose guide as claimed in claim 1, wherein the revolvable device comprises a plurality of spaced apart vertically aligned outer surface portions.

3. An irrigation hose guide as claimed in claim 2, wherein the outer surface portions are spaced to accommodate the irrigation nodes therebetween.

4. An irrigation hose guide as claimed in claim 2, wherein the outer surface portions are separated by a plurality of recesses adapted to accommodate the irrigation nodes.

5. An irrigation hose guide as claimed in claim 2, wherein the outer surface portions are adapted to frictionally engage the irrigation hose/nodes such that movement of the irrigation hose/nodes relative to the irrigation hose guide can cause the revolvable device to rotate.

6. An irrigation hose guide as claimed in claim 1, wherein the revolvable device is in the form of a reel.

7. An irrigation hose guide as claimed in claim 6, wherein the reel comprises at least one hub and a frame connected thereto.

8. An irrigation hose guide as claimed in claim 6, wherein the reel comprises upper and lower reel portions separated by the plurality of outer surface portions.

9. An irrigation hose guide as claimed in claim 8, wherein each outer surface portion comprises a flexible strap connected between the upper and lower reel portions.

10. An irrigation hose guide as claimed in claim 8, wherein the upper and lower reel portions each comprise a rim and a plurality of spokes connecting the rim to the hub.

11. An irrigation hose guide as claimed in claim 1, wherein the ground engaging portion is a freestanding base.

12. An irrigation system comprising:
a hose adapted to be connected at one end to a water source;
a plurality of irrigation nodes along the hose; and
one or more irrigation hose guides as claimed in claim 1,
wherein the hose is adapted to be towed by a vehicle to position the hose for irrigation, and the irrigation hose guides are positioned at one or more points at which the towed hose needs to be re-directed.

13. An irrigation system as claimed in claim 12, wherein each irrigation node comprises a sprinkler head and protective pod.

14. A method of setting up an irrigation system comprising the step of:
positioning one or more irrigation hose guides as claimed in claim 1 at one or more points at which the irrigation hose is required to change direction.

15. A method as claimed in claim 14, wherein the method further comprises towing an irrigation hose having a plurality of irrigation nodes along its length to an irrigation position such that the irrigation hose may be towed around the irrigation hose guides and changes direction around the irrigation hose guides.

16. A method as claimed in claim 14, wherein each irrigation node comprises a sprinkler head and protective pod.

17. A method as claimed in claim 15, wherein the method comprises towing the irrigation hose such that the hose contacts the irrigation hose guides and slides in relation thereto, causing the irrigation hose guides to rotate.

18. A method as claimed in claim 15, wherein the irrigation hose is towed using a vehicle.

19. A method as claimed in claim 18, wherein the method comprises hitching the irrigation hose to the vehicle.

20. A method of irrigating comprising the steps of:
positioning one or more irrigation hose guides as claimed in claim 1 at one or more points at which an irrigation hose is required to change direction;
towing an irrigation hose having a plurality of irrigation nodes along its length to an irrigation position such that the irrigation hose is towed around the irrigation hose guides and changes direction around the irrigation hose guides; and
connecting a water supply to the irrigation hose.
